(19) United States
(12) Patent Application Publication
(10) Pub. No.: US 2011/0163949 A1
(43) Pub. Date: Jul. 7, 2011

(54) CONTROL SYSTEM USING PORTABLE ELECTRONIC DEVICE FOR PERFORMING OPERATIONS

(76) Inventors: Chao-Tsung Chen, Beipu Township (TW); Chin-Shan Jao, Zhubei City (TW)

(21) Appl. No.: 12/683,629

(22) Filed: Jan. 7, 2010

(51) Int. Cl. G06F 3/033

(52) U.S. Cl. 345/157; 345/1.3; 455/41.3; 345/173; 455/414.1

(57) ABSTRACT

A control system using a portable electronic device for performing operations comprises a portable electronic device and one of a plurality of monitors. During performing operations, the portable electronic device simulates a mouse to send control signals for controlling applications executed by the portable electronic device or remotely control applications executed in an operation processing device. Via sending signal with a wired cable or wireless connection, the images and sounds generated by the portable electronic device or the operation processing device are transmitted to and displayed with one or the plurality monitor.

### BACKGROUND OF THE INVENTION

1. Field of the Invention

The invention generally relates to a control system, in particular to a control system using a portable electronic device for performing operations.

2. Description of Prior Art

FIG. 1 is a schematic diagram of a prior art desktop computer. Typically, a desktop computer 10 utilizes user input interfaces of a mouse 20 and a keyboard 30 to control the desktop computer 10. One of the recent popular applications is to perform communication services of making internet phone calls via an internet phone mouthpiece 40 along with the communication application (such as Skype application) installed in the desktop computer 10.

With the advancement of the technology, portable electronic devices for mobile purposes such as a mobile phone, a Personal Digital Assistant (PDA), a Global Position System (GPS), or a MP3 walkman are designed to offer processing capability equivalent to a personal computer. In an example of a mobile phone, the new model is equipped with processor having faster computing speed and bigger memories. There are also more and more additional functions provided (such as wireless internet connection and Bluetooth communication connection). Also, most of the portable electronic devices adapt operating systems (OS) having a Graphical User Interface (GUI) such as iPhone OS from Apple Computer and Windows Mobile from Microsoft. To part of users, it is feasible to replace a conventional personal desktop computer 10 with a current mobile phone.

Although, a portable electronic device offers various functions, the display area and buttons of an input interface are limited as a result of compact dimensions and inevitably is inconvenient to operate and uncomfortable to watch. In contrast with familiarity of user interfaces of personal computers, users are unfamiliar with user input interfaces of these portable electronic devices and consequently cannot utilize the various functions delivered by the portable electronic devices. Further, a personal desktop computer 10 has user interfaces such as the mouse 20 or the keyboard 30 designed to control with easy operations; or is capable of making internet phone calls via internet phone mouthpiece 40. These devices are provided to work with one personal desktop computer 10 and cannot be used to control devices other than the desktop computer 10, which is an application limitation. Furthermore, many popular applications used in a portable electronic device cannot be executed on the personal desktop computer 10 (for example a third party application on an iPhone). Thus, it is desirable to people skilled in the art to develop technologies optimized the convenience, capability and compatibility of indispensible products in everyday life, such as personal desktop computers 10 and portable electronic devices.

The Taiwan invention patent the Patent No I298133 discloses a mobile electronic device having mouse function. The mobile electronic device simulates a mouse, where movements of the mobile electronic device generates simulating mouse control signal sent to a main computer in order to control the computer operations. However, it is a limitation that the simulated mouse is under the control of the main computer in the invention patent. Further, using a mobile electronic device as a mouse only is a waste of the operating system with high processing capability and the various functions such as wireless internet connection or Bluetooth communication connection delivered by the mobile electronic device. Further, the mobile electronic device simulates a mouse and is directly connected to the main computer for controlling operations. Therefore, the mobile electronic device cannot be used to control electronic products such as a television, a stereo system other than the main computer.

In brief, it is desirable in the market to provide a portable electronic device with functions, connectivity to other electronic devices and compatibility optimized.

### SUMMARY OF THE INVENTION

The main objective of the invention to provide a control system using a portable electronic device for performing operations where a portable electronic device simulates a operated to control application executed by the portable electronic device. The images and sounds generated are transmitted to and displayed with one or a plurality of monitors.

The another objective of the invention present invention is to provide a control system using a portable electronic device for performing operations where an operation processing device is used for offering extra functions and executing default functions of the portable electronic device, the portable electronic device simulates a mouse for controlling applications executed by the operation processing device, the images and sounds generated by the executed application are transmitted and displayed with one or a plurality of monitors during performing operations.

In order to obtain the above purposes, the portable electronic device simulates a mouse sending signals to control applications executed in a portable electronic device, or remotely control applications executed in an operation processing device during performing operations in the present invention. In addition, the images and sounds generated by the portable electronic device or operation processing device are transmitted to and displayed with one or a plurality of monitors via a wired cable or wireless connection.

In contrast with the prior art, the present invention offer advantages of replacing a conventional computer and a mouse with a portable electronic device and an operation processing device providing more diversified and convenient options to users based on operating means and user interfaces familiar to users. The portable electronic device and the operation processing device are used for searching data and download applications from the internet, where the data and applications can be saved in an add-on USB drive or a memory card. Also, the above-mentioned data of images and sounds generated are transmitted to and displayed with a monitor of larger display area instead of small display unit provided by the portable electronic device to deliver better display performance to users.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of a prior art desktop computer;

FIG. 2 is a schematic diagram of a control system of a preferred embodiment according to the present invention;

FIG. 3A is a connection schematic diagram of a preferred embodiment according to the present invention;

FIG. 3B is a connection schematic diagram of another preferred embodiment according to the present invention;

FIG. 3C is a connection schematic diagram of another preferred embodiment according to the present invention;

FIG. 4 is a connection schematic diagram of another preferred embodiment according to the present invention; and

FIG. 5 is a control schematic diagram of an electronic device used in a preferred embodiment according to the present invention.

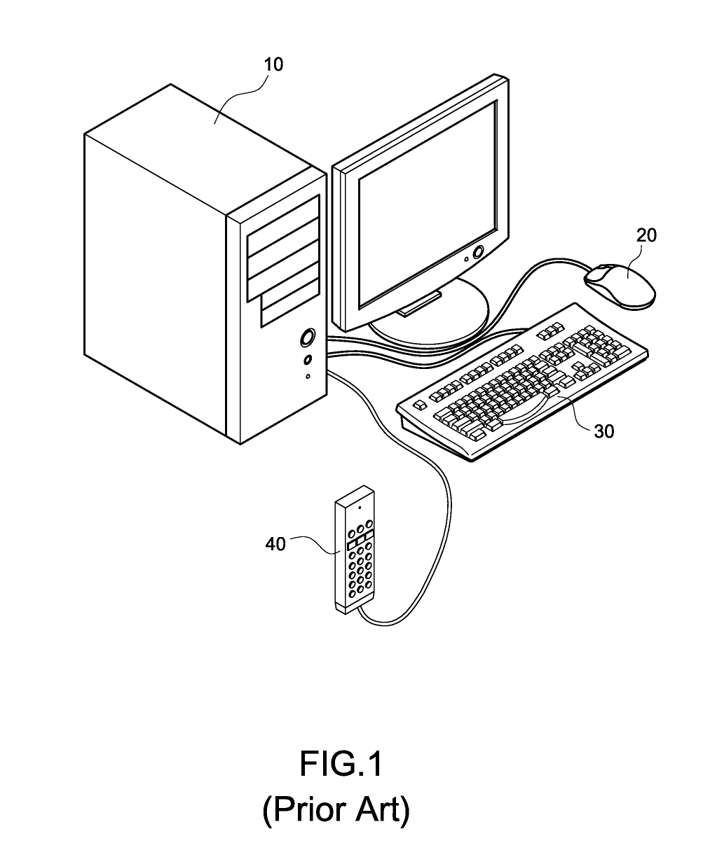

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

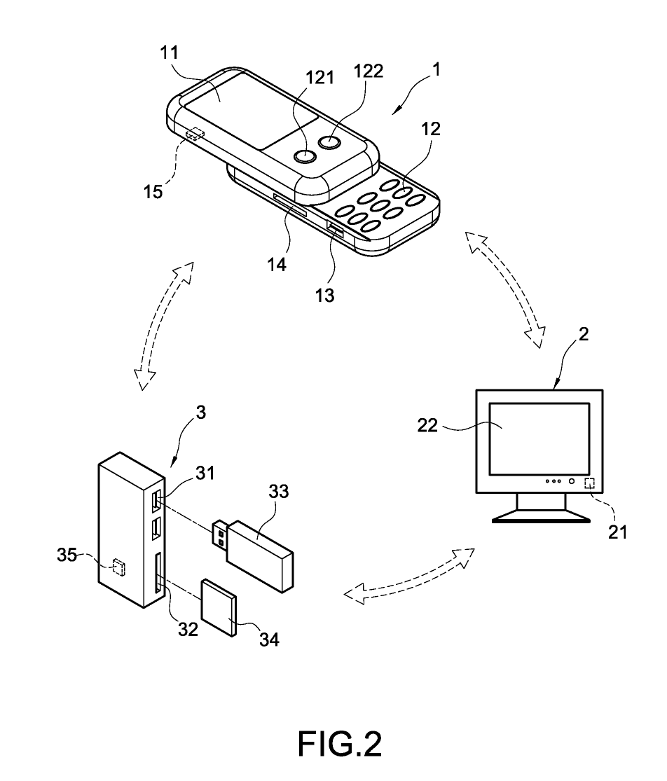

FIG. 2 is a schematic diagram of a control system of a preferred embodiment according to the present invention. The control system of the present invention mainly comprises a portable electronic device 1 (referred as the electronic device 1 in the following), a monitor 2 and an operation processing device 3. Though, the following preferred embodiments are offered as examples of possible embodiments according to the present invention, the above-mentioned components such as electronic device 1, the monitor 2 and the operation processing device 3 are applied depending on the required configuration in the embodiment and is not be limited by the preferred embodiments described in he following.

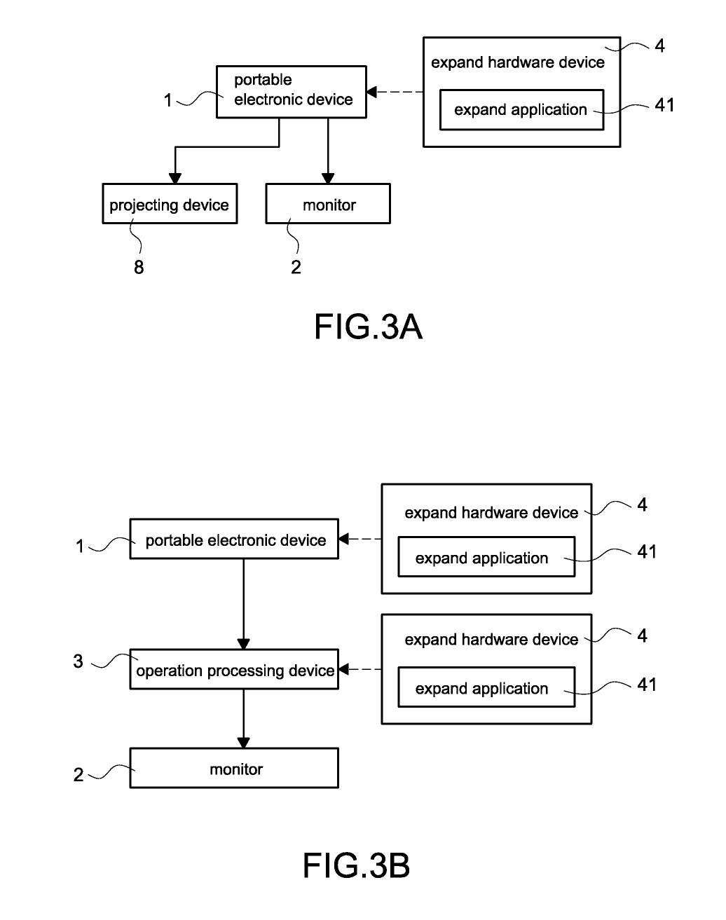

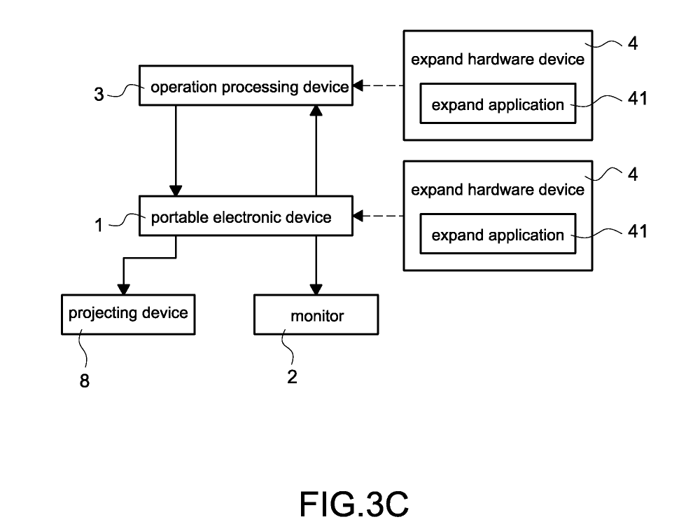

The electronic device 1 can be an electronic device such as a mobile phone, a Personal Digital Assistant (PDA), a Global Position System (GPS) or a MP3 player. In the FIG. 2, the preferred embodiment uses a mobile phone but the scope of the invention is not limited thereto. The electronic device 1 mainly comprises a display unit 11 and input units 12. An operating system is installed and executed in the electronic device 1. One or more than one applications are executed under the operating system. The electronic device 1 comprises one or more than one expanding slots for making connection with external expand hardware devices (for example, expand hardware devices 4 in FIG. 3A). The expanding slot can be a Universal Serial Bus (USB) slot 13 for making connection with the USB interface of the expand hardware devices 4 for example a USB portable drive and an external hard drive. Further, the expanding slot can be a memory card slot 14 for making connection with memory cards compatible with a memory card format selected from a group of memory card formats applicable to the memory card slot for example a Multimedia Card (MMC), a Secure Digital Card (SD Card) or a Memory Stick (MS).

The electronic device 1 may comprise other additional functions for example the electronic device 1 is a mobile phone for making phone calls, wireless internet connection (via a wireless network card), Bluetooth communication connection, and infrared connection, taking photos, playing multimedia files and projection. The display unit 11 can be a touch control display unit 11. The display unit 11 and the input units 12 can be one unit. A control signal is triggered and sent by users touching the control display unit 11. However, if the display unit 11 is not a touch control display unit 11, then the input unit s12 is a conventional control button for example a talk button 121 and an end button 122 on a mobile phone. The electronic device 1 may further comprise a first Bluetooth transceiver 15 for wireless data transmission for example transmitting data from the electronic device 1 to an external hardware device (such as the operation processing device 3) for storage or execution. Further, images and sounds played with the display unit 11 in the electronic device 1 can be transmitted to and displayed with an external display device such as the monitor 2 by the first Bluetooth transceiver 15.

The display area of the monitor 2 is larger than the display unit 11 of the electronic device 1. The monitor 2 can be a large size Liquid Chrystal Display (LCD) monitor, LCD television or plasma television and is not limited by the preferred embodiment. The monitor 2 comprises a second Bluetooth transceiver 21 for receiving wireless transmitted data such as the images and sounds transmitted and displayed with a display monitor 22 of the monitor 2 via the first Bluetooth transceiver 15 in the electronic device 1. In addition to wireless receiving data via the second Bluetooth transceiver 21, the monitor 2 receives data via a wired cable. For example, if the monitor 2 is a LCD television, the monitor 2 receives television signals transmitted from external setup box (such as the operation processing device 3) and displays the television signals.

The operating system and the applications are saved and executed in the operation processing device 3. Further, the operation processing device 3 has higher processing capability than the electronic device 1 and can be used for processing operating system and applications which the electronic device 1 are not capable of processing. The operation processing device 3 has one or more than one expanding slots. The expanding slot can be a USB slot 31 or a memory card slot 32 for making connection with expand hardware devices 4 such as a USB device 33 and a memory card 34. The operation processing device 3 has a third Bluetooth transceiver 35 for wireless data transmission or receiving wireless transmitted data. For example, the third Bluetooth transceiver 35 wirelessly receives the control signal sent by the electronic device 1 to control the executed operating system and applications in the operation processing device 3, or wireless transmits images and sounds generated by the operation processing device 3 to the monitor 2 (illustrated in the following).

The expand hardware devices 4 such as the USB device 33 and the memory card 34 are installed with expand applications 41 for expanding functions of the electronic device 1 or the operation processing device 3. In the example of the USB device 33, the USB device 33 is a wireless network card, or a 3.5G wireless network card for making connection with the electronic device 1 or the operation processing device 3. The electronic device 1 or the operation processing device 3 connects with the wireless network card, and executes connection application in the wireless network card to establish internet connection via the wireless network card. In another example, the USB device 33 is an internet television interface card, the electronic device 1 or the operation processing device 3 receives internet television signals via the internet television interface card. The electronic device 1 or the operation processing device 3 acts as the above-mentioned external setup box. The images and sounds generated of the internet television signal are transmitted to and displayed with the display monitor 22 of the monitor 2. Further, the electronic device 1 or the operation processing device 3 is connected to a power supply device such as a solar charger (not shown in the diagram) via the USB slot 13 or 31 to charge the electronic device 1 or the operation processing device 3.

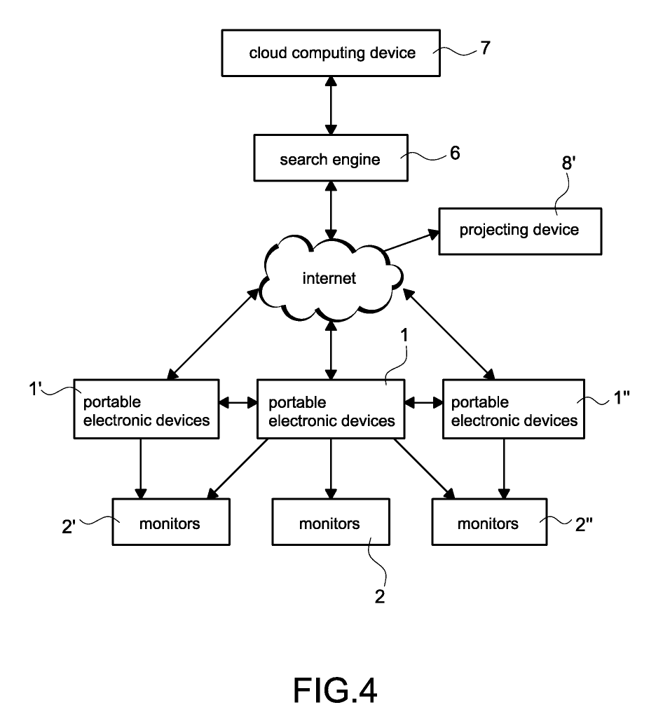

It should be noted that if the electronic device 1 or the operation processing device 3 is connected to the internet, the electronic device 1 or the operation processing device 3 performs internet search via a search engine (such as the search engine 6 in FIG. 4) to locate a required expand applications 41. The search engine transmits search result of the expand applications 41 to the electronic device 1 or the operation processing device 3. The expand applications 41 are saved and executed in the electronic device 1 or the operation processing device 3. Further, when the result data is transmitted to the electronic device 1, the electronic device 1 wireless transmits the data to one of the surrounding storage devices for data storage via the first Bluetooth transceiver 15.

FIGS. 3A, 3B and 3C are connection schematic diagrams of various preferred embodiments according to the present invention. Refer to FIG. 3A, the control system of the present invention mainly comprises the electronic device 1 and the monitor 2 in the preferred embodiment. The electronic device 1 executes the operating system and the application saved. The images and sounds displayed on the display unit 11 of the electronic device 1 are wireless transmitted to and displayed with the display monitor 22 of the monitor 2 via the first Bluetooth transceiver 11 and the second Bluetooth transceiver 21 of the monitor 2. The electronic device 1 is connected to expand hardware devices 4 such as the USB device 33 and the memory card 34 via the USB slot 13 and the memory card slot 14, and executes the expand applications 41 saved in the expand hardware devices 4. The images and sounds generated are transmitted to and displayed with the display monitor 22 of the monitor 2. Thus, users are allowed to use the images and sounds on the monitor 2 as reference for controlling the electronic device 1 rather than relying on small size display unit 11 on the electronic device 1 so as to provide a more convenient and diversified means to control the electronic device 1.

It should be noted that the above-mentioned control system is provided to transmit the images and sounds generated by the electronic device 1 to the monitor having larger display area than the display unit 11. In order to achieve the above, the electronic device 1 may use a projecting device 8 for projecting the above images and playing the sounds. Thus, users are allowed to reference the larger image projected, and perform operations on the electronic device 1. If the projecting device 8 has Bluetooth communication connection, the images and sounds generated by the electronic device 1 wireless can be transmitted to and projected with the projecting device 8 via the first Bluetooth transceiver 15. Further, the electronic device 1 is connected to a USB interface projecting device 8 (such as a portable projecting device) via the USB slot 13. The electronic device 1 is connected via a wired cable or wireless connection to the projecting device 8 to transmit the images and sounds generated by the electronic device 1.

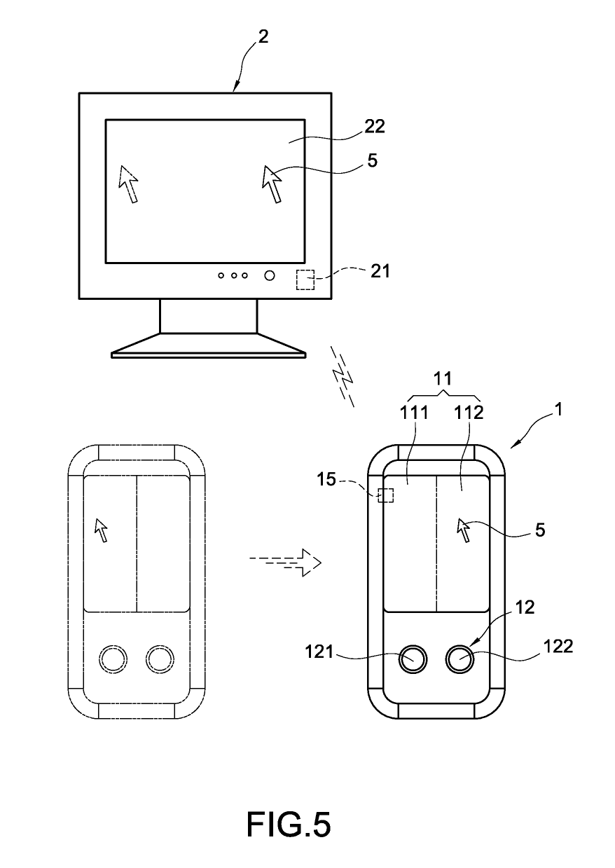

FIG. 5 is a control schematic diagram of an electronic device used in a preferred embodiment according to the present invention. The electronic device 1 simulates a mouse during performing operations operated to send the control signal controlling the electronic device 1. For example, when the installed operating system using Graphical User Interface (GUI) is executed in the electronic device 1, the movement of the electronic device 1 is used to control displayed cursor of the operating system to move the cursor in a direction and by distance corresponding to the movement. If the display unit 11 of the electronic device 1 is a touch control display unit 11, the touch control display unit 11 simulates mouse by allocating two operating sections 111 and 112. These operating section 111 and 112 simulate the left click button and the right click button of a mouse to receive user input. Further, when the electronic device 1 is a mobile phone, the talk button 121 and the end button 122 on the electronic device 1 respectively simulate the left click button and the right click button of a mouse. The above-mentioned preferred embodiments of present invention should not be used to limit the scope of the invention.

The above-mentioned images and sounds generated during performing operations in the electronic device 1 are displayed with the display unit 11. However, images and sounds displayed on in present invention display unit 11 are simultaneously wirelessly transmitted to and displayed with the display monitor 22 of the monitor 2 via the first Bluetooth transceiver 15 and the second Bluetooth transceiver 21. Thus users are allowed to reference image and sounds displayed on the monitor 2 for controlling the electronic device 1 to avoid misunderstanding on the operation status and giving incorrect instructions as a result.

In the preferred embodiment in the FIG. 3B, the control system comprises the electronic device 1, the operation processing device 3 and the monitor 2. The operation processing device 3 is used for executing the operating system and the application. The electronic device 1 sends send the control signals for controlling the operating system and the application executed by the operation processing device 3 via performing operations with the control method as shown in the FIG. 4. The images and sounds generated from executing the operating system and the application by operation processing device 3 are transmitted to and displayed with the display monitor 22 of the monitor 2 via the third Bluetooth transceiver 35 of the operation processing device 3, and the second Bluetooth transceiver 21 of the monitor 2 transmit wireless signals.

It should be noted that because the operation processing device 3 has higher processing capability than the electronic device 1, the electronic device 1 is only used for control instead of executing any operating systems and applications. The operation processing device 3 is connected to the expand hardware devices 4 and executes the expand applications 41 saved in the expand hardware devices 4 via the USB slot 31 or the memory card slot 32. The electronic device 1 is used for making connection with the expand hardware devices 4 and receiving the expand applications 41 saved in the expand hardware devices 4. The expand applications 41 are transmitted to the operation processing device 3 for execution via a wired cable or wireless connection. The electronic device 1 and the operation processing device 3 are connected by a USB cable or wirelessly connected by the first Bluetooth transceiver 15 and the third Bluetooth transceiver 35. There are other connection methods known to people skilled in the art present invention and should not limit the scope of the present invention.

For example, the electronic device 1 is regarded as a computer mouse, the operation processing device 3 as the main computer, and the monitor 2 as a computer display in the above embodiment. The electronic device 1 sends a mouse control signal for controlling the operating system and the application executed by the operation processing device 3. The images and sounds are transmitted to and displayed with the monitor 2 by the operation processing device 3. Further, the electronic device 1 is regarded as a remote controller, the operation processing device 3 is regarded as a setup box, and the monitor 2 is regarded as a television. The operation processing device 3 receives the television signal via television cable. The received television signal images and sounds generated are transmitted to and displayed with the display monitor 22 of the monitor 2 via a wired cable or wireless connection. The electronic device 1 transmits wireless control signals for controlling selecting channel or adjusting sound volume via the first Bluetooth transceiver 15 and the third Bluetooth transceiver 35 of the operation processing device 3. If the electronic device 1 is a mobile phone, the electronic device 1 also is used for making phone calls when performing operations. Or, the electronic device 1 enables the internet connection application in the operation processing device 3 to establish the internet connection, and executes a communication application saved in the operation processing device 3 (such as a SKYPE) to make internet phone calls. The above-mentioned preferred embodiments of present invention should not be used to limit the scope of the invention.

In the preferred embodiment in the FIG. 3C, the control system comprises the operation processing device 3, the electronic device 1 and the monitor 2. The difference between embodiments in FIG. 3B and FIG. 3 is that the operation processing device 3 does not transmit data directly to the monitor 2. For example, the operation processing device 3 is regarded as a main computer, the electronic device 1 is regarded as a wireless mouse, and the monitor 2 is regarded as a television. Users uses the electronic device 1 in the living room remotely controlling the operation processing device 3 in a bed room for controlling executed the operating system and the application by the operation processing device 3 via the first Bluetooth transceiver 15 and the third Bluetooth transceiver 35 transmit wireless signals. The electronic device 1 wireless receives the images and sounds generated by the operation processing device 3 via the third Bluetooth transceiver 35. Next, the electronic device 1 is used as transmission interface transmitting the received images and sounds, to and displayed with the display monitor 22 of the monitor 2. Further, the electronic device 1 is connected to the projecting device 8 via a wired cable (with the USB slot 13) or wireless connection (with the first Bluetooth transceiver 15). Thus, the images and sounds are transmitted and projected with the projecting device 8. Users are no longer required to sit in front of the personal computer. Instead, users are allowed to watch operation status of the operation processing device 3 as the following operation references displayed on the monitor 2 or a projected screen having a larger display area. Such application offers convenience and operation flexibility to users. In the preferred embodiment in the FIG. 3C, the electronic device 1 and the operation processing device 3 are also connected to the expand hardware devices 4 to receive the expand applications 41 saved in the expand hardware devices 4. The expand applications 41 are executed by the operation processing device 3 and controlled via the electronic device 1. Lastly, the images and sounds of the operation processing device 3 are transmitted to and displayed with the display monitor 22 of the monitor 2 using the electronic device 1 as transmission interface.

FIG. 4 is a connection schematic diagram of another preferred embodiment according to the present invention. In FIG. 4, the control system present invention comprises a plurality of electronic devices (1, 1′, 1″) and monitors (2, 2′, 2″). There are three electronic devices 1, 1′, 1″ and the monitors 2, 2′, 2″ used in the preferred embodiment. The preferred embodiment should not be used to limit the scope of the present invention.

The images and sounds of the electronic device 1 are simultaneously transmitted and displayed with the plurality of monitor 2, 2′ and 2″ via the first Bluetooth transceiver 15 or via internet connection of the electronic device 1. Users control the operating system and the application executed by the electronic device 1. The images and sounds are transmitted to and displayed with the monitor 2, 2′ and 2″ to various users to watch acting as a video conference. Further, the images and sounds generated from a plurality of various application executed by the electronic device 1 are respectively transmitted to and displayed with various monitor 2, 2′, 2″ by users. For example, the images and sounds generated by making wireless internet connection in the electronic device 1 are transmitted to and displayed with the monitor 2, and the images and sounds generated by making video phone calls in the electronic device 1 are transmitted to and displayed with another monitor 2′. Thus, users reference the display on the monitor 2 for controlling status making internet connection and reference the display on the monitor 2′ for making video phone calls.

Also, the electronic devices 1, 1′ and 1″ are interconnected via the Bluetooth network or the internet and jointly control the application (such as a game application) executed in the electronic device 1. The images and sounds are transmitted to and displayed with the monitor 2 by the electronic device 1. The images and sounds generated by executing the game application are transmitted to and displayed with a plurality of monitor 2, 2′ and 2″ by the electronic device 1. Thus, the plurality of users controls the electronic devices 1, 1′ and 1″ respectively for performing interactive games. The plurality of users watches the interactive game on the monitor 2, 2′ and 2″ respectively. Further, the same game application can be saved in and executed by and controlled by the electronic devices 1, 1′ and 1″. The control signals are transmitted via the Bluetooth network or the internet for jointly controlling the plurality of game applications executed in the electronic devices 1, 1′ and 1″. The images and sounds generated are transmitted and displayed with the monitor 2, 2′ and 2″. Thus, execution and controls on a plurality of game applications are simultaneous and users are allowed to perform interactive games together with several electronic devices and monitors.

However, when the electronic device 1 is connected to the internet, the electronic device perform searches on the expand applications 41 with the search engine and also search on required data with the search engine 6. The searched data are transmitted to a cloud computing device 7 for execution and computing. The cloud computing device is a super computing center. The cloud computing device has superior processing capability than the electronic device 1 and the operation processing device 3. As the data processing is completed, the cloud computing device 7 transmits the processing result to the electronic device 1 or the operation processing device 3 via the search engine 6 for storage or execution purposes. As mentioned above, the electronic device 1 wireless transmits the processing result to any of the surrounding storage devices for storage purpose via the first Bluetooth transceiver 15. Further, users may enable the authentication to view or to hide the electronic device 1 and users desire to access to the electronic device 1 are allowed. If the electronic device 1 is connected to the internet, the images and sounds of the electronic device 1 are transmitted to and projected with a remote projecting device 8′. Thus, the remote projecting device 8′ projects received data and local users of the projecting device 8′ are allowed to watch and listen to the images and sounds. In this case, images and sounds of the electronic device 1 are not displayed locally with the monitor 2 or the projecting device 8.

As mentioned above, a plurality of users jointly control operations of applications executed in the electronic device 1, 1′ and 1″ via interconnection. The images and sounds of the electronic devices 1, 1′ and 1″ are transmitted to and displayed with respective corresponding monitors 2, 2′ and 2″. Nonetheless, users may enable an authorization mechanism requesting a user to receive authentication issued by the other users before access to and control the electronic device of other users for protecting data safety. Also, authentication is required before images and sounds are transmitted to and displayed with the monitor of other users.

As the skilled person will appreciate, various changes and modifications can be made to the described embodiments. It is intended to include all such variations, modifications and equivalents which fall within the scope of the invention, as defined in the accompanying claims.

What is claimed is:

1. A control system using a portable electronic device for performing operations comprising:
a portable electronic device comprising a display unit and a first Bluetooth transceiver, the portable electronic device executing an operating system and an application saved internally; and
a monitor having a second Bluetooth transceiver and having a display dimensions larger than the display dimensions of the display unit;
wherein, the portable electronic device transmit wireless signals via the first Bluetooth transceiver and the second Bluetooth transceiver in the monitor wirelessly, images and sounds generated by executing the operating system and the application in the portable electronic device are transmitted to and displayed with the monitor; and the portable electronic device simulates a mouse operated to control the executing operating system and the application in the portable electronic device during performing the operations.

2. The control system of claim 1, wherein the display unit is a touch control display unit, the touch control display unit has two operating sections, the two operating sections simulate a left click button and a right click button on the mouse operated to receive user input by clicking when the portable electronic device simulates the mouse.

3. The control system of claim 1, wherein the portable electronic device has an expanding slot used for connecting to an expand hardware device and executes an expand application saved in the expand hardware device, the expanding slot is a memory card slot or a universal serial bus (USB) slot, the expand hardware device is a memory card compatible with a memory card format selected from a group of memory card formats applicable to the memory card slot, or a USB device compatible with USB interface.

4. The control system of claim 3, wherein the portable electronic device connected via a wired cable or wireless connection to a projecting device, or connected to a remote projecting device via internet, the images and the sounds generated by executing the operating system and the application in the portable electronic device are transmitted to and projected with the projecting device or the remote projecting device.

5. The control system of claim 3, wherein the portable electronic device is a mobile phone, the mobile phone simulates the mouse and a talk button and an end button of the mobile phone simulate a left click button and a right click button on the mouse operated to receive user input by clicking.

6. The control system of claim 5, wherein the expand hardware device is a wireless network card and the mobile phone is connected to the internet via the wireless network card searching for required expand applications to download and execute on the mobile phone.

7. The control system of claim 6, wherein the mobile phone is connected to a search network via internet and transmits searched data on the search network to a cloud computing device for processing, the cloud computing device transmits processing result via the search network upon processing to the mobile phone, the processing result is transmitted by the mobile phone wirelessly and saved in one of the storage devices within the wireless signal reception range, and the access to the saved data is open to or hidden from users.

8. The control system of claim 1, wherein the control system has a plurality of the portable electronic devices, one of plurality of the portable electronic devices executes the application, and the plurality of portable electronic devices are interconnected and transmit a control signal via a Bluetooth network or internet whereby the plurality of portable electronic devices commonly control operations of the application executed in the portable electronic device.

9. The control system of claim 1, wherein, the control system has a plurality of the portable electronic devices, the plurality of the portable electronic device respectively execute the same application, and the plurality of portable electronic devices are interconnected and transmit a control signal via a Bluetooth network or internet whereby the plurality of portable electronic devices commonly control operations of the application respectively executed in the portable electronic device.

10. The control system of claim 1, wherein, the control system has a plurality of the monitor, the portable electronic device transmit wireless signals via the first Bluetooth transceiver and the second Bluetooth transceivers in the plurality of the monitors, whereby images and sounds generated by executing the operating system and the application in the portable electronic device are wirelessly transmitted to and displayed with the plurality of the monitors.

11. A control system using a portable electronic device for performing operations comprising:
an operation processing device having a third Bluetooth transceiver, executing an operating system and an application saved internally;
a portable electronic device connected to the operation processing device, sending a control signal to control the operating system and the application executed in the operation processing device; and
a monitor having a second Bluetooth transceiver for wirelessly receiving images and sounds generated by executing the operating system and the application in the operation processing device via the second Bluetooth transceiver and displaying the images and sounds;
wherein the portable electronic device simulates a mouse operated to control the executing operating system and the application in the operation processing device during performing the operations

12. The control system of claim 11, wherein the display unit is a touch control display unit, the touch control display unit has two operating sections, the two operating sections simulate a left click button and a right click button on the mouse operated to receive user input by clicking when the portable electronic device simulates the mouse.

13. The control system of claim 11, wherein the operation processing device and the portable electronic device have an expanding slot used for connecting to an expand hardware device, the operation processing device executes an expand application saved in the expand hardware device, the expanding slot is a memory card slot or a universal serial bus (USB) slot, the expand hardware device is a memory card compatible with a memory card format selected from a group of memory card formats applicable to the memory card slot, or a USB device compatible with USB interface.

14. The control system of claim 13, wherein the expanding slot is connected to a power supply device having a connecting port using USB interface whereby the portable electronic device or the operation processing device is powered.

15. The control system of claim 13, wherein the portable electronic device is a mobile phone, the mobile phone simulates the mouse and a talk button and a end button of the mobile phone simulate a left click button and a right click button on the mouse operated to receive user input by clicking.

16. The control system of claim 15, wherein the expand hardware device is a wireless network card, the mobile phone is connected to the internet via the wireless network card searching for required expand applications to download and execute on the mobile phone.

17. The control system of claim 16, wherein the mobile phone is operated to make phone calls or connect to internet via the operation processing device and execute a communication application for making internet phone calls via the mobile phone when the mobile phone performs operations.

18. The control system of claim 11, wherein the operation processing device is connected to a television cable for receiving a television signal and under the control of the portable electronic device; and the received the television signal of the generated images and sounds are transmitted to and display on the monitor.

19. The control system of claim 11, wherein the portable electronic device further comprises a first Bluetooth transceiver, and the second Bluetooth transceiver and the third Bluetooth transceiver for transmitting wireless signals, the portable electronic device wirelessly sends the control signal for controlling the operating system and the application executed by the operation processing device, the operation processing device transmits the images and sounds generated to the portable electronic device, the images and sounds subsequently are wirelessly transmitted to and displayed on the monitor by the portable electronic device while the portable electronic device are utilized as a mouse and a transmission interface.

20. The control system of claim 11, wherein the portable electronic device comprising a first Bluetooth transceiver and the third Bluetooth transceiver for transmitting wireless signals, the portable electronic device is connected via a wired cable or wireless connection to a projecting device or is connected to a remote projecting device via internet, the portable electronic device wirelessly sends the control signal for controlling the operating system and the application executed by the operation processing device, the operation processing device transmits the images and sounds generated to the portable electronic device, the images and sounds subsequently are wirelessly transmitted to and projected with the projecting device or the remote projecting device by the portable electronic device.
